(19) United States
(12) Patent Application Publication
(10) Pub. No.: US 2014/0200847 A1
(43) Pub. Date: Jul. 17, 2014

(54) WRIST-BASED SPEED AND DISTANCE MONITORING

(71) Applicant: Garmin Switzerland GmbH, Schaffhausen (CH)

(72) Inventors: Dheeraj Singiresu, Overland Park, KS (US); Christopher A. Johnson, Spring Hill, KS (US)

(73) Assignee: Garmin Switzerland GmbH, Schaffhausen (CH)

(21) Appl. No.: 14/157,247

(22) Filed: Jan. 16, 2014

Related U.S. Application Data
(60) Provisional application No. 61/753,752, filed on Jan. 17, 2013.

(51) Int. Cl. G01P 15/00

(52) U.S. Cl. CPC G01P 15/00
USPC 702/141

(57) ABSTRACT

A method and apparatus for determining a current speed of a wrist-worn mobile electronic device. In some configurations, a wrist-worn mobile electronic device is provided that includes a motion sensor configured to sense motion of the user's wrist and generate acceleration data, a position determining module, a non-transitory memory configured to store scale factors corresponding to a plurality of average acceleration points, and a processor operable to determine a cadence for the user, an average acceleration of the user's wrist, select a scale factor and compute a current speed for the mobile electronic device based on the cadence, determined average acceleration and selected scale factor.

### CROSS-REFERENCE TO RELATED APPLICATIONS

This application claims priority to U.S. Provisional Application No. 61/753,752 filed on Jan. 17, 2013, entitled: “Wrist-Based Speed and Distance Monitoring”, which is hereby incorporated by reference in its entirety.

### BACKGROUND

Foot pods containing accelerometers are often used to calculate a user's cadence and the speed and distance traveled by the user as he or she runs based on acceleration signals generated by the accelerometers. These foot pods are typically paired with a running watch (often GPS enabled) to provide various feedback and information to the user. Unfortunately, it can be burdensome for the user to remember to use the foot pod (in addition to the running watch) and it can be cumbersome or difficult to clip the foot pod to the user's shoe.

### SUMMARY

Embodiments of the present technology provide a wrist-worn mobile electronic device operable to compute a current speed based on a determined cadence, a determined average acceleration and a scale factor. The wrist-worn mobile electronic device broadly comprises a motion sensor, position determining module, non-transitory memory and processor. The motion sensor is configured to sense motion of the user's wrist and generate acceleration data. The position determining module is operable to receive one or more signals to determine a current geographic location of the mobile electronic device. The non-transitory memory configured to store at least portions of the acceleration data and a scale factor corresponding to a plurality of average acceleration points. The processor may determine, based on the acceleration data, a cadence for the user and an average acceleration of the user's wrist, select a scale factor using the determined average acceleration, and compute a current speed for the mobile electronic device based on the cadence, determined average acceleration and selected scale factor.

### BRIEF DESCRIPTION OF THE DRAWINGS

FIG. 1 is a schematic block diagram of components of a mobile electronic device environment in accordance with one or more embodiments of the present disclosure.

FIG. 2 is a perspective view of the mobile electronic device of FIG. 1.

FIG. 3 is another mobile electronic device environment in accordance with one or more embodiments of the present disclosure.

FIG. 4 is a plot of cadence versus speed measurements.

FIG. 5 is a plot of average acceleration versus speed measurements.

FIG. 6 is an exemplary plot of scale factors for a plurality of average acceleration points.

FIG. 7 is a plot of calibration-based estimates of speed and location-based speed measurements versus time.

### DETAILED DESCRIPTION

Speed and distance may be determined if a current geographic position may be accurately determined. For example, devices including a GPS receiver may utilize GPS signals to determine a current geographic location. If the device moves from a geographic location, a distance between the first location and a second location may be determined. A current speed may be determined by evaluating the distance traveled with respect to time.

Early ideas for speed monitoring with an accelerometer came from using a foot pod, as it allows for a clear zero point for every step and there are fairly well-known dynamics. However, a drawback associated with using a foot pod is that it requires use of a separate accessory.

Conventional devices are commonly calibrated by requiring users to manually enter calibration coefficients and/or truth distances to calibrate the devices to enable the determination of speed and distance estimates. For example, conventional devices may recommend that a user visit an area having a known distance that may be traveled (e.g., oval running track), enter the distance around the track into the device and then run along the track for the entered distance in an attempt to calibrate the device. This calibration event occurs only when desired by the user by initiating and performing a sequence of acts related to calibration.

A wrist-based motion sensor (e.g., accelerometer) may be used instead of a foot pod to compute user speed and/or distance based on measured acceleration. In embodiments of the present invention, the magnitude of the acceleration at the user's wrist, which may be roughly proportional to the speed at which a user is running, is used to compute a current speed and/or distance traveled by the user. To help calculate accurate speed information, embodiments of the present invention can automatically modify the criteria utilized to estimate distance and speed based on reliable distance information to fit the characteristics of each user. The speed and distance estimation techniques described herein reduce human error and significantly add to the overall user experience.

Embodiments of the present invention provide a simple, effective model for using reliable distance information (e.g., GPS-based measurements) to refine a stored motion model used to calculate speed and distance. This functionality allows for measurement and estimation of speed and distance based on movements of a user's wrist for a single user or a wide segment of the population, which includes casual users as well as fitness enthusiasts. The estimated distance calculations enable accurate measurements when more reliable positioning techniques, such as GPS, are not continuously available.

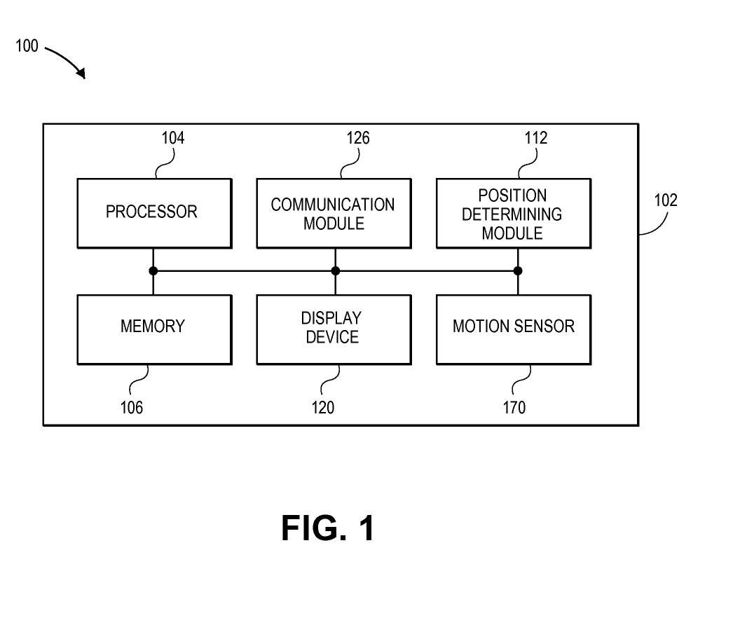

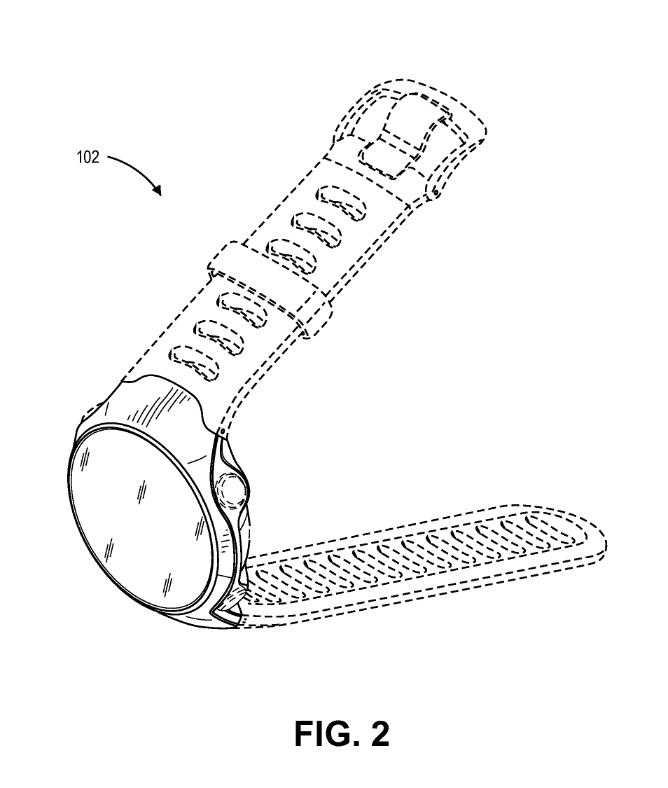

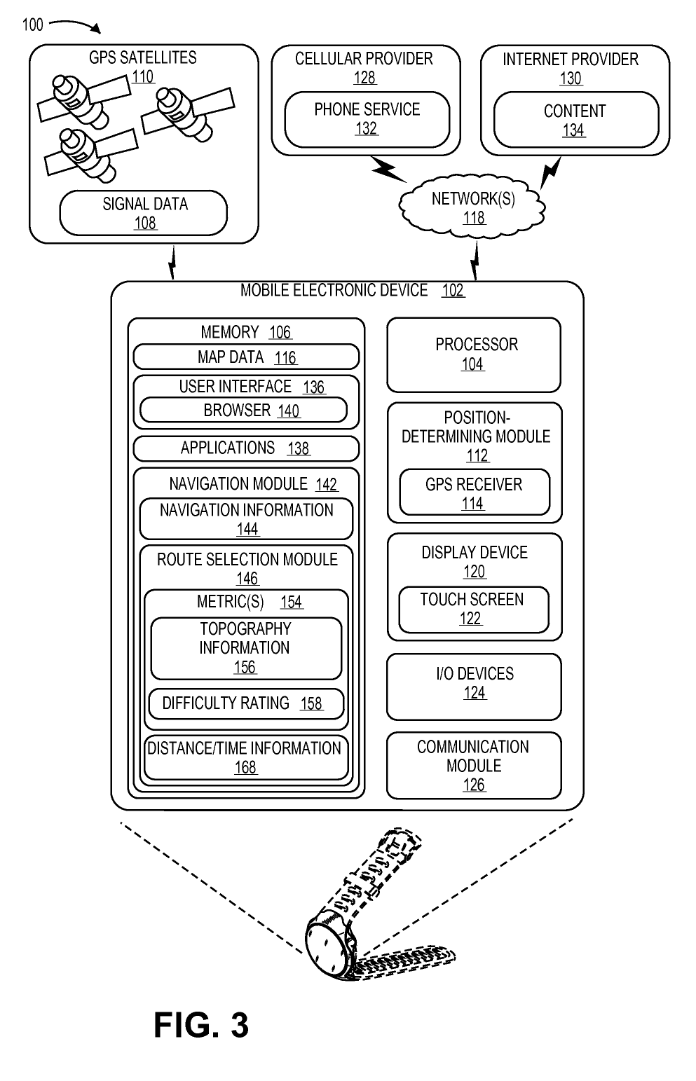

Embodiments of the technology will now be described in more detail with reference to the drawing figures. The wrist-based speed and distance monitoring functionality described herein may be used in combination with the following example environment. Referring initially to FIGS. 1-3, an example mobile electronic device environment 100 including a mobile electronic device 102 that is operable to perform the techniques discussed herein is illustrated. The electronic device environment 100, as seen in FIGS. 1 and 3, illustrates an example mobile electronic device 102 that is operable to perform the techniques discussed herein. The mobile electronic device 102 broadly comprises a processor 104, a memory 106, a position determining device 112, a display 120, a communication module 126 and a motion sensor 170. FIG. 2 illustrates an additional example of the mobile electronic device 102, where the mobile electronic device 102 is specifically configured as a watch operable to utilize the wrist-based speed and distance functionality described herein. In other configurations, the mobile electronic device 102 may be configured as a bracelet, band, pod, module, or other electronic device operable to be secured around a user's wrist or arm.

The mobile electronic device 102 may be configured in a variety of ways. For instance, a mobile electronic device 102 may be configured for use during fitness and/or sporting activities and comprise a cycle computer, a sport watch, a golf computer, a smart phone providing fitness or sporting applications (apps), a hand-held GPS device used for hiking, and so forth. However, it is contemplated that the techniques may be implemented in any mobile electronic device that includes navigation functionality. Thus, the mobile electronic device may also be configured as a portable navigation device (PND), a mobile phone, a hand-held portable computer, a tablet computer, a personal digital assistant, a multimedia device, a media player, a game device, combinations thereof, and so forth. In the following description, a referenced component, such as mobile electronic device 102, may refer to one or more entities, and therefore by convention reference may be made to a single entity (e.g., the mobile electronic device 102) or multiple entities (e.g., the mobile electronic devices 102, the plurality of mobile electronic devices 102, and so on) using the same reference number.

Processor 104 provides processing functionality for the mobile electronic device 102 and may include any number of processors, micro-controllers, or other processing systems, and resident or external memory for storing data and other information accessed or generated by the mobile electronic device 102. The processor 104 may execute one or more software programs that implement the techniques and modules described herein. The processor 104 is not limited by the materials from which it is formed or the processing mechanisms employed therein and, as such, may be implemented via semiconductor(s) and/or transistors (e.g., electronic integrated circuits (ICs)), and so forth.

In embodiments, processor 104 may be operable to determine, based on acceleration data generated by motion sensor 170, a cadence for the user wearing the mobile electronic device 102. Processor 104 may also determine, based on the acceleration data generated by motion sensor 170 and stored in memory 106, an average acceleration of the user's wrist. Processor 104 may select a scale factor, stored in memory 106 corresponding to a plurality of average acceleration points, using the determined average acceleration of the user's wrist. In embodiments, processor 104 may compute a current speed for the mobile electronic device 102 based on one or more of the determined cadence, determined average acceleration and the selected scale factor. Processor 104 may compute a distance traveled by mobile electronic device 102 based on the determined speed and the time over which acceleration data of interest was generated by motion sensor 170.

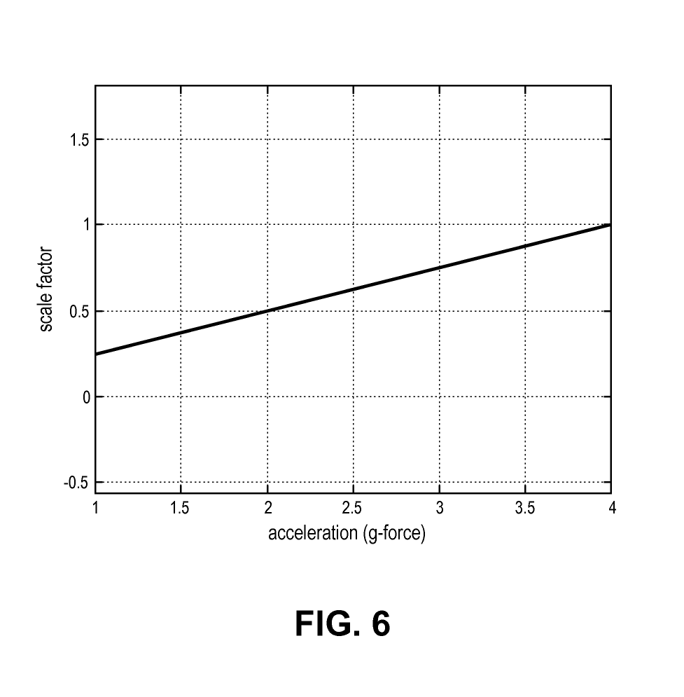

The mobile electronic device 102 includes a non-transitory memory 106. Memory 106 may be device-readable storage media that provides storage functionality to store various data associated with the operation of the mobile electronic device 102, such as motion data, software programs, or other data to instruct the processor 104 and other elements of the mobile electronic device 102 to perform the techniques described herein. Memory 106 may be configured to store at least portions of the acceleration data generated by motion sensor 170 and one or more scale factors corresponding to a plurality of average acceleration points. For instance, as shown in FIG. 6, a unique scale factor may be associated with every increment of average acceleration, such that a stored scale factor may be identified and selected for any average acceleration value. The average acceleration may increment by any interval (e.g., 1.0 g, 0.5 g, 0.1 g, 0.05 g, etc.). In embodiments, the scale factors may be stored in a lookup table within the memory 106. Memory 106 may also store the speed computed by processor 104 and/or the distance computed by processor 104 for a short or long period of time. Memory 106 may store one or more scale factors for a variety of user characteristics (e.g., gender, height, weight, conditioning, etc.). Memory 106 may include a unique identifier or similar technique to associate the stored content with one or more users who may wear mobile electronic device 102. Memory 106 may also store one or more user profiles to associate stored information with each user of the shared mobile electronic device 102.

Although a single memory 106 is shown, a wide variety of types and combinations of memory may be employed. The memory 106 may be integral with the processor 104, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The mobile electronic device 102 may include functionality to determine position. The position determining module 112 is operable to receive one or more signals to determine a current geographic location of the mobile electronic device 102. For example, mobile electronic device 102 may receive signal data 108 transmitted by one or more position data platforms and/or position data transmitters, examples of which are depicted as the GPS satellites 110. More particularly, mobile electronic device 102 may include a position-determining module 112 that may manage and process signal data 108 received from Global Positioning System (GPS) satellites 110 via a GPS receiver 114. The position-determining module 112 is representative of functionality operable to determine a geographic position through processing of the received signal data 108. The signal data 108 may include various data suitable for use in position determination, such as timing signals, ranging signals, ephemerides, almanacs, and so forth.

Position-determining module 112 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide position/location information, timing information, speed information, and a variety of other navigation-related data. Accordingly, the position-determining module 112 may be configured in a variety of ways to perform a wide variety of functions. For example, the position-determining module 112 may be configured for outdoor navigation, vehicle navigation, aerial navigation (e.g., for airplanes, helicopters), marine navigation, personal use (e.g., as a part of fitness-related equipment), and so forth. Accordingly, the position-determining module 112 may include a variety of devices to determine position using one or more of the techniques previously described.

As shown in FIG. 3, the position-determining module 112, for instance, may use signal data 108 received via the GPS receiver 114 in combination with map data 116 that is stored in the memory 106 to generate navigation instructions (e.g., turn-by-turn instructions to an input destination or POI), show a current position on a map, and so on. Position-determining module 112 may include one or more antennas to receive signal data 108 as well as to perform other communications, such as communication via one or more networks 118 described in more detail below. The position-determining module 112 may also provide other position-determining functionality, such as to determine an average speed, calculate an arrival time, and so on. Although a GPS system is described and illustrated in relation to FIG. 3, it should be apparent that a wide variety of other positioning systems may also be employed, such as other global navigation satellite systems (GNSS), terrestrial based systems (e.g., wireless-phone based systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros, odometers, and magnetometers), use of “dead reckoning” techniques, and so on.

The mobile electronic device 102 may include a display 120 to display information to a user of the mobile electronic device 102. The display 120 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 120 may be backlit via a backlight such that it may be viewed in the dark or other low-light environments. In embodiments, display 120 may be provided with a touch screen 122 to receive input (e.g., data, commands, etc.) from a user. For example, a user may operate the mobile electronic device 102 by touching the touch screen 122 and/or by performing gestures on the screen 122. In some embodiments, the touch screen 122 may be a capacitive touch screen, a resistive touch screen, an infrared touch screen, combinations thereof, and the like. The mobile electronic device 102 may further include one or more input/output (I/O) devices 124 (e.g., a keypad, buttons, a wireless input device, a thumbwheel input device, a trackstick input device, and so on). The I/O devices 124 may include one or more audio I/O devices, such as a microphone, speakers, and so on.

Mobile electronic device 102 may include a communication module 126 enabling data to be transmitted or received by the mobile electronic device 102. Communication module 126 is representative of communication functionality to permit mobile electronic device 102 to send/receive data between different devices (e.g., components/peripherals) and/or over the one or more networks 118, as shown in FIG. 3. Communication module 126 may be representative of a variety of communication components and functionality including, but not limited to: one or more antennas; a browser; a transmitter and/or receiver; a wireless radio; data ports; software interfaces and drivers; networking interfaces; data processing components; and so forth.

The mobile electronic device 102 may also include a motion sensor 170. The motion sensor 170 is configured to sense motion of the user's wrist and generate acceleration data. The motion sensor 170 generates motion data, such as acceleration data, for use by other components of mobile electronic device 102. For instance, motion sensor 170 may provide acceleration of mobile electronic device 102 while worn on the wrist of a user. The motion sensor 170 may include accelerometers, tilt sensors, inclinometers, gyroscopes, combinations thereof, or other devices including piezoelectric, piezoresistive, capacitive sensing, or micro electromechanical systems (MEMS) components. The motion sensor 170 may sense motion along one axis of motion or multiple axes of motion, such as the three orthogonal axes X, Y, and Z. The motion sensor 170 generally communicates motion data to the processor 104 and stores the motion data in memory 106. The rate at which the motion sensor 170 communicates and/or stores motion data may vary from approximately 1 hertz (Hz) to approximately 1 kHz. However, any rate may be employed.

The motion sensor 170 generally senses motion of the mobile electronic device 102 and, in turn, the user wearing mobile electronic device 102 on a wrist, arm or other portion of the user's body (e.g., torso, leg, ankle, etc), carrying mobile electronic device 102 or having mobile electronic device 102 attached to clothing or accessories commonly stored on the user's body (e.g., keys, workplace security badge, etc.). Motion sensor 170 may sense motion of the user wearing the mobile electronic device 102 associated with swimming (e.g., number of strokes, length of strokes, etc.), skating (e.g., ice skating, inline skating, etc.), skiing, rowing, bicycling, aerobics, or any other physical activity.

FIG. 3 illustrates an example mobile electronic device environment 100 that is operable to perform the techniques discussed herein. Through functionality represented by communication module 126, the mobile electronic device 102 may be configured to communicate via one or more networks 118 with a cellular provider 128 and an Internet provider 130 to receive mobile phone service 132 and various content 134, respectively. Content 134 may represent a variety of different content, examples of which include, but are not limited to: map data, which may include route information; web pages; services; music; photographs; video; email service; instant messaging; device drivers; real-time and/or historical weather data; instruction updates; and so forth. Wireless networks 118 include, but are not limited to: networks configured for communications according to: one or more standard of the Institute of Electrical and Electronics Engineers (IEEE), such as 802.11 or 802.16 (Wi-Max) standards; Wi-Fi standards; Bluetooth standards; ANT protocol; and so on. Wired communications are also contemplated such as through universal serial bus (USB), Ethernet, serial connections, and so forth.

The mobile electronic device 102 is illustrated as including a user interface 136, which is storable in memory 106 and executable by the processor 104. The user interface 138 is representative of functionality to control the display of information and data to the user of the mobile electronic device 102 via the display 120. The user interface 136 may provide functionality to allow the user to interact with one or more applications 138 of the mobile electronic device 102 by providing inputs via the touch screen 122 and/or the I/O devices 124. For example, the user interface 136 may cause an application programming interface (API) to be generated to expose functionality to an application 138 to configure the application for display by the display 120 or in combination with another display.

Applications 138 may comprise software, which is storable in memory 106 and executable by the processor 104, to perform a specific operation or group of operations to furnish functionality to the mobile electronic device 102. Example applications may include fitness applications, exercise applications, health applications, diet applications, cellular telephone applications, instant messaging applications, email applications, photograph sharing applications, calendar applications, address book applications, and so forth.

In implementations, the user interface 136 may include a browser 140. The browser 140 enables the mobile electronic device 102 to display and interact with content 134 such as a webpage within the World Wide Web, a webpage provided by a web server in a private network, and so forth. The browser 140 may be configured in a variety of ways. For example, the browser 140 may be configured as an application 138 accessed by the user interface 136.

The mobile electronic device 102 is illustrated as including a navigation module 142, which is storable in memory 106 and executable by the processor 104. The navigation module 142 represents functionality to access map data 116 that is stored in the memory 106 to provide mapping and navigation functionality to the user of the mobile electronic device 102. For example, the navigation module 142 may generate navigation information that includes maps and/or map-related content for display by display 120. As used herein, map related content includes information associated with maps generated by the navigation module 142 and may include route information, POIs, information associated with POIs, map legends, controls for manipulation of a map (e.g., scroll, pan, etc.), street views, aerial/satellite views, and the like, displayed on or as a supplement to one or more maps. The navigation module 142 may utilize position data determined by the position-determining module 112 to show a current position of the user (e.g., the mobile electronic device 102) on a displayed map, furnish navigation instructions (e.g., turn-by-turn instructions to an input destination or POI), calculate traveling distances and times, and so on. The navigation module 142 further includes a route selection module 146, which is also storable in memory 106 and executable by the processor 104, to display route selection information 148. In the implementation shown, the route selection information 148 is illustrated in the format of a map page 150 that includes a route graphic 152 representing a route that may be traversed by a user of the mobile electronic device 102.

The association between speed and acceleration and the association between speed and cadence is unique to each user. Embodiments of the present invention utilize a scale factor to personalize the association for each user because the motion characteristics associated with one user may not be apply to other users. Scale factors that may be calibrated to fit the motion characteristics of one or more users of mobile electronic device 102 based on a distance computed for the geographic locations determined over the time period over which the acceleration data was sensed by motion sensor 170 reflect the unique motion characteristics of each user. For example, two users who share mobile electronic device 102 may have unique scale factors and acceleration data. Thus, the scale factors and acceleration data for each user may be stored separately in memory 106. Applying customized computations for each user enables mobile electronic device 102 to provide accurate speed and distance information to each user. Unlike conventional devices that perform a calibration only when initiated by the user (e.g., by entering a calibration coefficient, truth distance, etc.), embodiments of the present invention continuously calibrate the stored scale factors based on acceleration data sensed by motion sensor 170 and current geographic locations determined by position determining module 112 as the mobile electronic device 102 is used.

Embodiments of the present disclosure estimate the stride length as the product of an average acceleration measured at the user's wrist and a scale factor corresponding to the measured average acceleration. Consequently, speed may be estimated by the product of an average acceleration measured at the user's wrist and a scale factor corresponding to the measured average acceleration and cadence. In embodiments, the scale factor may change with the intensity of acceleration of the arm swing and wrist movement, which may be proportional to the user's stride length, and other user characteristics. Use of a dynamic scale factor that is customized to account for bodily movements (e.g., arm, feet, torso, etc.) sensed for each user eliminates the need for a fixed model to approximate the relationship between the scale factor and the measured characteristics (e.g., average acceleration, cadence, etc.) for all users.

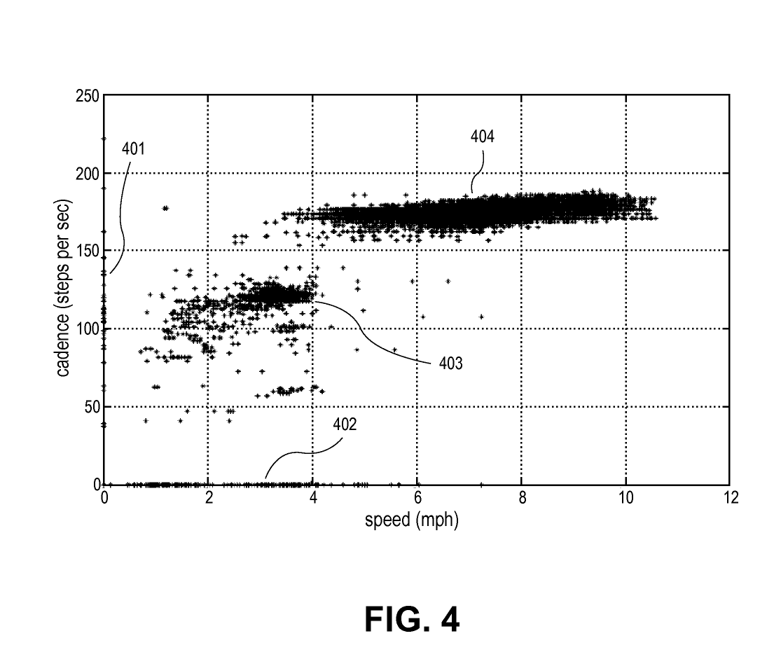

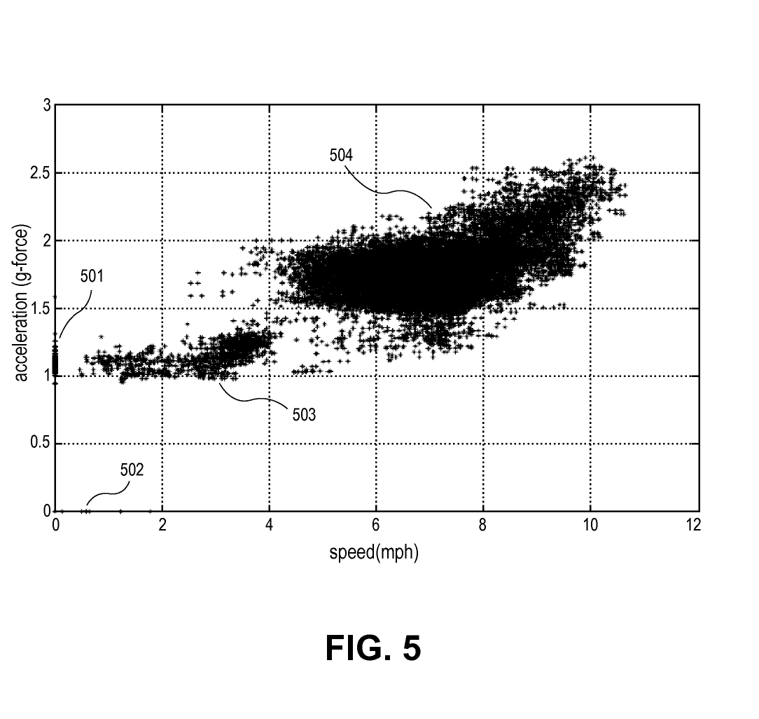

As shown in FIGS. 4 and 5, plots of cadence and average acceleration versus speed for a single user illustrate the diversity of cadence and acceleration values that may be associated with any speed. A general correlation is visible, as are the running and walking regions on both graphs.

The mobile electronic device 102 may store 3-axis accelerometer data in a buffer within memory 106. The motion sensor 170 in the wrist-worn mobile electronic device 102 may sense motion caused by the user's feet and the user's wrist around which the mobile electronic device 102 is worn. For example, motion sensor 170 may sense the jerk of a foot striking the ground (e.g., pavement, track, stairs, etc.), the pendulum-like motion of the user's arm and torso movements as the user of mobile electronic device 102 runs or walks. The stored acceleration data may be used to determine cadence. As shown in FIG. 4, cadence data region 403 generally relates to a user of mobile electronic device 102 while he was walking and cadence data region 404 generally relates to a user of mobile electronic device 102 while he was running.

In embodiments, processor 104 may correlate the most recent samples in the buffer against the older samples in the buffer to determine the user's current cadence. A cadence for a user wearing the mobile electronic device 102 may be determined by correlating acceleration data generated by motion sensor 170 for a first period of time with acceleration data for a second period of time. For instance, the second period of time may occur prior to the first period of time such that the more recent acceleration data is correlated against earlier acceleration data by processor 104 and the length of the second period of time may be greater than the first period of time.

Due to the fact that the motion sensor 170 may sense motion that does not originate from the user's wrist (e.g., foot strikes, torso movements, etc.), the correlation of acceleration data over the first period of time and the second period of time may enable processor 104 to identify a dominant repetitive motion for all of the sensed movements, the frequency of which may strongly correspond to the user's cadence. In embodiments, the acceleration data associated with the most recent first period of time and second period of time may be retained in memory 106 as motion sensor 170 continues to generate acceleration data. In embodiments, the frequency of a dominant repetitive motion identified by performing a correlation of the acceleration data generated by motion sensor 170 may be determined to be a current cadence.

In embodiments, processor 104 may determine that an aspect of the dominant repetitive motion tends to be strongly correlated with a particular source of acceleration that is sensed by motion sensor 170. For instance, processor 104 may determine that the dominant repetitive motion identified by the correlation corresponds to the pendulum-like swing of the user's arm instead of the user's feet striking the ground or other motion. Similarly, processor 104 may determine that the dominant repetitive motion identified by the correlation corresponds to the motion of the user's torso. Cadence determined during these conditions is commonly one-half of the user's foot cadence. The determined cadence may correct or account for this variation from step cadence based on footsteps. An advantage to the disclosed method is that cadence calculated using this method will be accurate even if the user's arm movements do not continuously correspond to the speed at which at user is traveling. For example, a user. may stop swinging his watch arm, such as holding up his arm to look at display 120, or alter the characteristics of his arm movements. Use of a predetermined acceleration thresholds would not account for such inconsistencies and may not be effective for all users.

In embodiments, location-based speed may be determined before cadence is determined. Cadence data 401 depicted along the vertical axis of FIG. 4 may be associated with a substantially stationary user (e.g., user takes a break stops and thereby no longer moves to a different geographic location). Cadence data 402 depicted along the horizontal axis of FIG. 4 may be associated with a lag period during which an adequate number of acceleration data points is collected and stored in memory 106 in order to determine cadence. Cadence data 402 may also be caused by error resulting from locations determined by the position determining module 112.

In embodiments, the mobile electronic device 102 may compute cadence by applying auto-correlation techniques to the acceleration data. The current stride length may be computed by applying a scale factor to the average acceleration measured at the runner's wrist. The motion data may be evaluated for any length of time (e.g., 1 sec, 2 sec., etc.). The autocorrelation techniques described herein may determine cadence by identifying repeating patterns in acceleration data. The frequency of a dominant repetitive motion observed in the accelerometer data can be found by identifying peaks associated with the dominant repetitive motion that is made apparent by correlating acceleration data sensed by motion sensor 170. A frequency determined for the dominant repetitive motion may correspond to the user's actual cadence.

In some configurations, erroneous data (movement that does not relate to a step) may be filtered out from data replied upon to determine cadence. The acceleration data may be examined to evaluate whether it includes a forward and backward motion by the user's arm, a length of the movement and device orientation.

The stored acceleration data may also be used to determine an average acceleration of the user's wrist over a period of time (e.g., 1 sec, 10 sec, etc.). As shown in FIG. 5, acceleration data region 503 generally relates to a user of mobile electronic device 102 while he was walking and acceleration data region 504 generally relates to a user of mobile electronic device 102 while he was running. Acceleration data 501 and cadence data 401 may be identified as ‘dead speed’ or erroneous and excluded from calculations to determine speed and/or distance. In embodiments, processor 104 may identify acceleration data 502 associated with a zero g acceleration and exclude acceleration data 502 from computations of a current speed and/or distance. A determined average acceleration sensed at the user's wrist may enable selection of a scale factor. Thus, an average acceleration for the user's wrist, determined based on acceleration data generated by motion sensor 170, may be used to compute a current speed and/or distance.

One or more scale factors may be stored in a lookup table in memory 106. In embodiments, the scale factors may be stored in increments for a range of average acceleration that may be measured at the user's wrist. For example, the scale factors stored in the lookup table may be populated based on the average acceleration sensed at the runner's wrist, cadence and/or the GPS speed (when a GPS fix is available). In embodiments, an approximate scale factor may be calculated (e.g., linear interpolation) if the scale factor corresponding to the current average acceleration measured at the runner's wrist value is not stored in memory 106.

Scale factors stored corresponding to a plurality of average acceleration points, such as in a lookup table, may be selected from based on the average acceleration measured at the runner's wrist. As shown in FIG. 6, the look up table may be populated with a plurality of scale factor values for a plurality of average acceleration measurements. The data stored in the lookup table may be linear or non-linear. For example, if motion sensor 170 generates acceleration data determined by processor 104 to have an average acceleration of 2.0 g, a scale factor associated with 2.0 g stored in memory 106 is selected to compute a current speed of mobile electronic device 102. Similarly, if motion sensor 170 generates acceleration data determined by processor to have an average acceleration of 1.5 g, a scale factor associated with 1.5 g stored in memory 106 is selected to compute a current speed of mobile electronic device 102. The stored average acceleration values may increment by 0.5 g, as shown in FIG. 6, or by any other interval (e.g., 1.0 g, 0.1 g, 0.05 g, etc.).

In embodiments, processor 104 may be operable to calibrate scale factors stored in memory 106 based on the acceleration data generated by motion sensor 170 and the geographic locations determined by a position determining device 112. For instance, the scale factors may be calibrated to fit the motion characteristics of one or more users of mobile electronic device 102 based on a distance computed for the geographic locations determined over the time period over which the acceleration data was sensed by motion sensor 170. For example, the user may run while using GPS features of the position determining module 112 to enable the mobile electronic device 102 to compute speed based on GPS position determinations. These GPS-based speed calculations may be compared with speed values calculated using wrist-based accelerations and the one or more scale factors may be modified such that the accelerometer-based speed performance matches the GPS-based speed calculations. Thus, when the user subsequently exercises without the use of a position determining module 112 (e.g., GPS) operable to determine current geographic locations, the mobile electronic device 102 may still accurately calculate speed and distance using accelerometer information sensed by motion sensor 170.

The distance computed based on geographic location information determined by position determining device 112 is commonly accurate and may be relied upon to modify the stored scale factors to result in more accurate estimated speed and distance computations, which incorporate the scale factors as described herein. In embodiments, the calibration of scale factors stored in memory 106 is based on the determined cadence, determined average acceleration and the distance computed for the determined geographic locations.

The mobile electronic device 102 may estimate distance and speed based on motion data received from a 3-axis accelerometer and specifically the determined cadence, determined average acceleration, and selected scale factor discussed above. Generally, speed over a period of time is determined by the product of the distance traveled in one step and the number of steps taken over that period of time. When evaluated for athletic activities, the distance traveled in one step is the stride length. Embodiments of the present disclosure can estimate the stride length as the product of an average acceleration measured at the user's wrist and a scale factor corresponding to the measured average acceleration. Thus, using this relationship, speed may be estimated by the product of an average acceleration measured at the user's wrist and a scale factor corresponding to the measured average acceleration (i.e., distance traveled in one step) and a measured cadence (i.e., the number of steps taken over that period of time):

Speed=C₁*accel*cad, where “C1” is the scale factor, “accel” is average acceleration, and “cad” is cadence.

Consequently, the estimated distance traveled may simply be calculated as the product of the estimated speed and time.

In embodiments, display 120 may be operable to present an indication of the determined speed and/or distance to the user of mobile electronic device 102. The current determined speed may be presented with fitness information or in a plot with past determined speed information. In embodiments, display 120 may present an estimated distance traveled by the user of mobile electronic device 102 during a training event. For instance, a user may utilize input/output (I/O) device 124 to indicate the beginning of a training event and track an estimated speed and/or distance traveled during this training event. The acceleration data, determined cadence, speed and distance associated with the training event may be stored in memory 106 and transmitted using communication module 126. Input/output (I/O) device 124 may be utilized to indicate the beginning of a training event, occurrence of course segments and/or the conclusion of a training event.

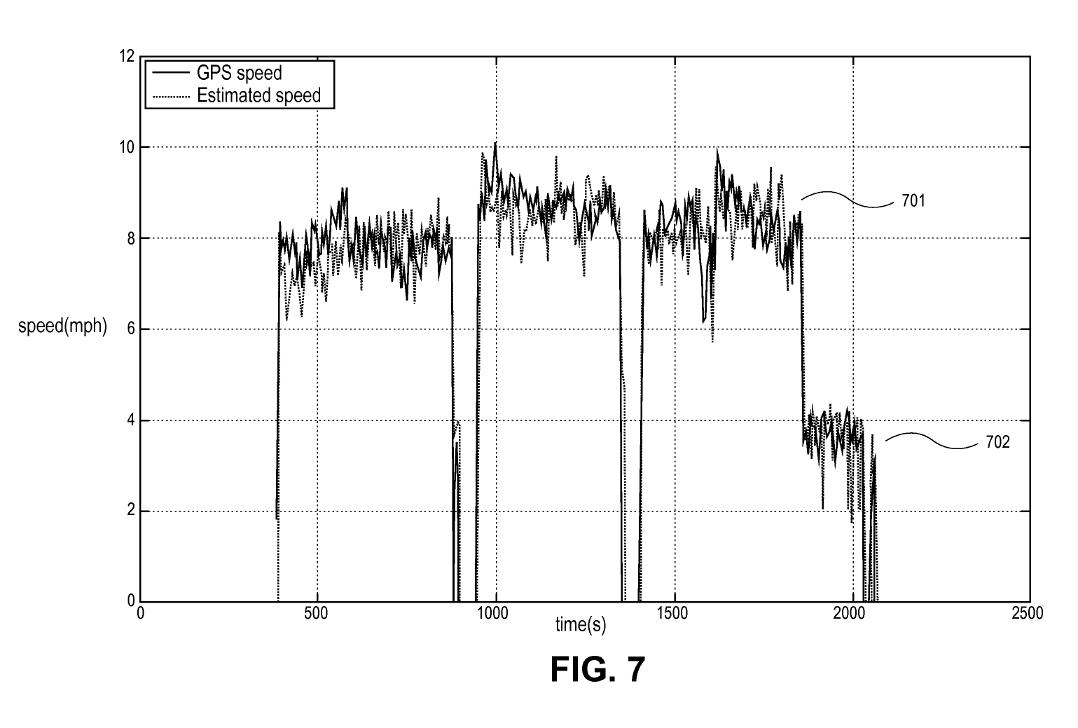

As shown in FIG. 7, a plot of speed as determined by a GPS receiver and speed as determined by the calibration techniques described herein depicts a very high degree of correlation between a GPS-measured speed and an estimated speed that was not determined based on location data. Speed data region 701 generally relates to a user of mobile electronic device 102 while he was running and speed data region 702 generally relates to a user of mobile electronic device 102 while he was walking with a high degree of accuracy. Because speed may be computed by the product of three weighted inputs, it may be helpful to remove ‘dead speed’ that may be present as a result of poor calibration or irregular use of mobile electronic device 102. In embodiments, erroneous data may be eliminated by requiring the measurement of positive cadence to account for a step to determine a current speed. This way, the device won't account for a speed when a step has not been taken by a user of the mobile electronic device 102.

Because the calibration techniques require use of computational resources of processor 104, it may be desirable to reduce the number of points used for the calibration and perform the speed computation using the reduced amount of data stored in a buffer of memory 106. Due to the limited range of values that may be required for the speed and/or distance estimations for many users, the number of acceleration data points used for the computations described herein may be reduced with little degradation of accuracy.

The user can transmit or upload the calibrated scale factors, acceleration data, computed speed, computed distance and other information stored in memory 106 through networks 119 to a computing device or internet provider 130 to a second mobile electronic device 102 or to a website (e.g., Garmin Connect) by using communication module 126. For example, mobile electronic device 102 may transmit the scale factors stored in memory 106 to a second mobile electronic device 102 or a website upon receiving a user input to input/output (I/O) device 124, such as a button. Similarly, the user can download one or more scale factors for use on mobile communication device 102. For example, acceleration data generated by motion sensor 170, one or more scale factors, determined cadence, speed computed by processor 104 and distance computed by processor 104 may be stored in memory 106 and communicated to a second mobile communication device 102 or to a website, such as Garmin Connect, by transmitting the information through networks 119 to a computing device or internet provider 130 by using communication module 126.

The scale factors and acceleration data received by communication module 126 may be stored in memory 106. The one or more received scale factors may be selected and used by processor 104 to compute a current speed and distance traveled by the user of mobile electronic device 102. If the mobile electronic device 102 that receives the scale factors does not include a position determining module 112, it may rely on the received scale factors and corresponding acceleration, which may be calibrated for the user, to compute a current speed and/or distance for the mobile electronic device 102 based on the one or more received scale factors, determined cadence and determined average acceleration based on acceleration data generated by motion sensor 170 and described herein.

For instance, the user may replace a first mobile electronic device 102 with a second mobile electronic device 102. The communication module 126 may be operable to receive one or more scale factors and acceleration data through networks 119 from another mobile electronic device 102, a computing device (e.g., laptop, tablet, etc.) or internet provider 130 that can access a server for the website. The scale factors and corresponding acceleration data received by mobile electronic device 102 may be associated with the user of mobile electronic device 102 or other users of the website who may wear a similar mobile electronic device 102 and share certain physical and fitness characteristics.

In embodiments, the data transmitted or uploaded to a website, such as Garmin Connect, may maintain user profiles including scale factors, acceleration data, determined cadence, computed speed and/or distance and other information associated with each user. For example, the website may associate the most recently received scale factors as the preferred information for a user's user profile. The scale factors and acceleration data associated with a user may be downloaded to a user's device automatically or based on a user-initiated event. For example, the website may determine that a user profile includes a plurality of devices equipped with motion sensor 170 and then share scale factors and corresponding acceleration data with all of the devices associated with the user profile to reduce human error, improve ease of use and add to the overall user experience.

In embodiments, the website may generate and maintain default tables, which include scale factors and acceleration data, based on the information received from participating users. Default tables may be generated for users having a certain characteristic (e.g., gender, height, weight, fitness level, goals, etc.) based on users that share that characteristic. For example, a default table may be generated for males having a certain height and fitness level based on the scale factors, acceleration data, determined cadence and/or computed speed received from all users having those characteristics.

Although the technology has been described with reference to the embodiments illustrated in the attached drawing figures, it is noted that equivalents may be employed and substitutions made herein without departing from the scope of the technology as recited in the claims. It is to be understood that the appended claims are not necessarily limited to the specific features or acts described. Rather, the specific features and acts are disclosed as exemplary forms of implementing the claimed devices and techniques.

What is claimed is:

1. A wrist-worn mobile electronic device configured to be worn about a user's wrist, the device comprising:
a motion sensor configured to sense motion of the user's wrist and generate acceleration data;
a position determining module operable to receive one or more signals to determine a current geographic location of the mobile electronic device;
a non-transitory memory configured to store at least portions of the acceleration data and a scale factor corresponding to a plurality of average acceleration points; and
a processor coupled with the memory, the processor operable to—
determine, based on the acceleration data, a cadence for the user,
determine, based on the acceleration data, an average acceleration of the user's wrist,
select the scale factor using the determined average acceleration, and
compute a current speed for the mobile electronic device based on the cadence, determined average acceleration and selected scale factor.

2. The wrist-worn mobile electronic device as recited in claim 1, wherein a plurality of scale factors are stored in a lookup table within the memory.

3. The wrist-worn mobile electronic device as recited in claim 1, wherein the processor is further operable to calibrate the scale factors based on the acceleration data and the determined geographic locations.

4. The wrist-worn mobile electronic device as recited in claim 3, wherein the calibration of the scale factors is based on a distance computed for the geographic locations determined over the time period over which the acceleration data was sensed.

5. The wrist-worn mobile electronic device as recited in claim 4, wherein the calibration of scale factors is based on the determined cadence, determined average acceleration and the distance computed for the determined geographic locations.

6. The wrist-worn mobile electronic device as recited in claim 1, wherein the cadence is determined by correlating acceleration data for a first period of time with acceleration data for a second period of time, the second period of time preceding the first period of time.

7. The wrist-worn mobile electronic device as recited in claim 6, wherein the cadence corresponds to a dominant repetitive motion identified by the correlation.

8. The wrist-worn mobile electronic device as recited in claim 1, wherein the motion sensor includes an accelerometer.

9. The wrist-worn mobile electronic device as recited in claim 1, wherein the position determining module includes a satellite navigation system receiver.

10. The wrist-worn mobile electronic device as recited in claim 1, further including a display operable to present an indication of the determined speed.

11. The wrist-worn mobile electronic device as recited in claim 1, wherein the processor is further operable to compute a distance based on the determined speed.

12. A wrist-worn mobile electronic device configured to be worn about a user's wrist, the device comprising:
a motion sensor configured to sense motion of the user's wrist and generate acceleration data;
a display operable to present an indication of a current speed;
a position determining module operable to receive one or more signals to determine a current geographic location of the mobile electronic device;
a non-transitory memory configured to store at least portions of the acceleration data and scale factors corresponding to a plurality of average acceleration points; and
a processor coupled with the memory, the processor operable to—
determine, based on the acceleration data, a cadence for the user,
determine, based on the acceleration data, an average acceleration of the user's wrist,
calibrate the scale factors based on the acceleration data and the determined geographic locations,
select a scale factor using the determined average acceleration, and
compute the current speed for the mobile electronic device based on the cadence, determined average acceleration and selected scale factor.

13. The wrist-worn mobile electronic device as recited in claim 12, further including a communication module operable to receive the scale factors, wherein the received scale factors are stored in the memory.

14. The wrist-worn mobile electronic device as recited in claim 13, wherein the received scale factors are associated with the user.

15. The wrist-worn mobile electronic device as recited in claim 12, wherein the scale factors are initially based on gender.

16. The wrist-worn mobile electronic device as recited in claim 12, wherein the scale factors are stored in a lookup table within the memory and are calibrated based on the determined cadence, determined average acceleration and the distance computed for the determined geographic locations.

17. The wrist-worn mobile electronic device as recited in claim 12, wherein the calibration of the scale factors is based on a distance computed for the geographic locations determined over the time period over which the acceleration data was sensed.

18. The wrist-worn mobile electronic device as recited in claim 12, wherein the cadence is determined by correlating acceleration data for a first period of time with acceleration data for a second period of time, the second period of time preceding the first period of time.

19. A wrist-worn mobile electronic device configured to be worn about a user's wrist, the device comprising:
a motion sensor configured to sense motion of the user's wrist and generate acceleration data;
a display operable to present an indication of a current speed;
a position determining module operable to receive one or more signals to determine a current geographic location of the mobile electronic device;
a non-transitory memory configured to store at least portions of the acceleration data and scale factors corresponding to a plurality of average acceleration points; and
a processor coupled with the memory, the processor operable to—
determine, based on the acceleration data, a cadence for the user,
determine, based on the acceleration data, an average acceleration of the user's wrist,
calibrate the scale factors based on the acceleration data and the determined geographic locations,
select a scale factor using the determined average acceleration, and
compute the current speed for the mobile electronic device based on the cadence, determined average acceleration and selected scale factor;
wherein the calibration of the scale factors is based on a distance computed for the geographic locations determined over the time period over which the acceleration data was sensed.

20. The wrist-worn mobile electronic device as recited in claim 19, further including a communication module operable to receive the scale factors, wherein the received scale factors are stored in the memory and are calibrated based on the determined cadence, determined average acceleration and the distance computed for the determined geographic locations.
